(19) United States
(12) Patent Application Publication
(10) Pub. No.: US 2009/0010722 A1
(43) Pub. Date: Jan. 8, 2009

(54) Boring Bar Allowing Direct Tuning

(76) Inventor: Hsin-Tien CHANG, Tai-Ping City (TW)

Correspondence Address: Dr. BANGER SHIA, 102 Lindencrest Ct., Sugar Land, TX, 77479-5201, US

(21) Appl. No.: 11/773,874

(22) Filed: Jul. 5, 2007

(51) Int. Cl. B26D 1/04

(52) U.S. Cl. 407/93; 407/78; 407/87

(57) ABSTRACT

A boring bar that allows direct tuning includes a blade holder disposed at a terminal of a blade shaft; a blade central axis is disposed to the blade holder; another central axis for tuning is disposed at where by the side of blade holder; the tuning central axis and the central axis of execute angular deflection clockwise or counterclockwise to change precision of tuning amount.

### BACKGROUND OF THE INVENTION

(a) Field of the Invention

The present invention is related to an improved inner-diameter boring bar, and more particularly, to one that has a tuning screw directly mounted to a disposal blade to work with a gap angular side of the disposal blade to inch the disposal blade and allows setup of an angle of a tuning central axis by angles of the tuning screw and a fixation screw to lock the disposable blade depending on the working environment or the tuning amount required to achieve extremely precise tuning of bore or compensation due to normal tear and wear of the blade.

(b) Description of the Prior Art

Referring to FIG. 11 of the accompanying drawings, an adjustable boring bar 20 of the prior art adjusts position of a nut bed 22 by means of a screw 21 thus to control a radius R defined by a blade 24 at a distal end of an arm 23 and a central diameter for achieving the purpose of adjusting a bore diameter. However, the prior art is applicable only for rough boring process and fails to achieve precise tuning of bore size.

FIGS. 12, 13, and 14 show a U.S. Pat. No. 6,155,753 of the same author of the present invention. As illustrated in FIG. 15, a gap angle θ of a cutting edge of a blade 34 is equal to 7° (the angle varies depending on the individual manufacturer) and a specification of a tuning screw 33 is of M3×0.5 with a pitch P=0.5 mm, meaning, for every turn the tuning screw 33 makes (i.e. advancing for a full pitch, P), the blade 34 is allowed to travel for an adjustment distance D=P×tan θ→D=0.5×tan 7°=0.06 mm (rounded to second digital place) as illustrated in FIG. 16; and a boring amount of the blade 34 taking one turn is of 0.12 mm. Should a scale 331 of the tuning screw 33 be divided into twelve gradations, each gradation of tuning is equal to 0.01 mm of boring amount. Accordingly, for each gradation of the tuning screw 33 is turned, the boring bar would result in increase or decrease of 0.01 mm boring amount.

The second prior art is characterized in that a tuning function is provided by taking advantage of the pitch P of the tuning screw 33 in conjunction with the gap angle of the cutting edge of the blade 34 while a central axis 320 for tuning and a central axis 310 are in parallel with each other. Therefore, tuning amount created by longitudinal displacement of the tuning screw 33 is only related to the size of the pitch P of the tuning screw 33 and the gap angle θ of the disposable blade 34 thus to prevent further change of the tuning amount of the blade 34.

### SUMMARY OF THE INVENTION

The primary purpose of the present invention is to provide a boring bar that allows direct tuning. To achieve the purpose, the present invention is essentially comprised of a blade holder disposed at a terminal of a blade shaft; a blade central axis is disposed to the blade holder; another central axis for tuning is disposed at where by the side of blade holder; the tuning central axis and the central axis of execute angular deflection clockwise or counterclockwise to change precision of tuning amount.

### BRIEF DESCRIPTION OF THE DRAWINGS

FIG. 1 is a perspective view of the present invention.

FIG. 2 is a bird's view of the prevent invention.

FIG. 3 is a sectional view taken from A-A of FIG. 2.

FIG. 4 is a schematic view showing a tuning of a blade of a preferred embodiment of the present invention wherein a tuning central axis deflects counterclockwise.

FIG. 5 is a schematic view showing a displacement delta of a movement of a tuning screw of a preferred embodiment of the present invention wherein a tuning central axis deflects counterclockwise.

FIG. 6 is a schematic view showing a displacement delta of a disposable blade movement due to the tuning screw of the preferred embodiment of the present invention wherein a tuning central axis deflects counterclockwise.

FIG. 7 is a schematic view showing the tuning central axis of the present invention deflects clockwise.

FIG. 8 is a schematic view showing the blade is tuned when the tuning central axis of the present invention deflects clockwise.

FIG. 9 is a schematic view showing a displacement delta of a movement of the tuning screw of another preferred embodiment of the present invention wherein the tuning central axis deflects clockwise.

FIG. 10 is a schematic view showing a displacement delta of a disposable blade movement due to the tuning screw of another preferred embodiment of the present invention wherein a tuning central axis deflects clockwise.

FIG. 11 is a layout of a boring bar for tuning of the prior art.

FIG. 12 is a perspective view of a U.S. Pat. No. 6,155,753.

FIG. 13 is a bird's view of the U.S. Pat. No. 6,155,753.

FIG. 14 is a sectional of the U.S. Pat. No. 6,155,753 as assembled.

FIG. 15 is a sectional view showing a blade in the U.S. Pat. No. 6,155,753.

FIG. 16 is a schematic view showing a displacement delta of movement of a tuning screw in the U.S. Pat. No. 6,155,753.

### DETAILED DESCRIPTION OF THE PREFERRED EMBODIMENTS

A boring bar allowing direct tuning of the present invention changes precision of displacement in tuning a disposable blade by having a tuning central axis, together with a center of a blade, to execute angular deflection clockwise or counterclockwise so to design an angle for the tuning central axis to change precision of tuning amount depending on the precision of a work piece processed with the boring bar.

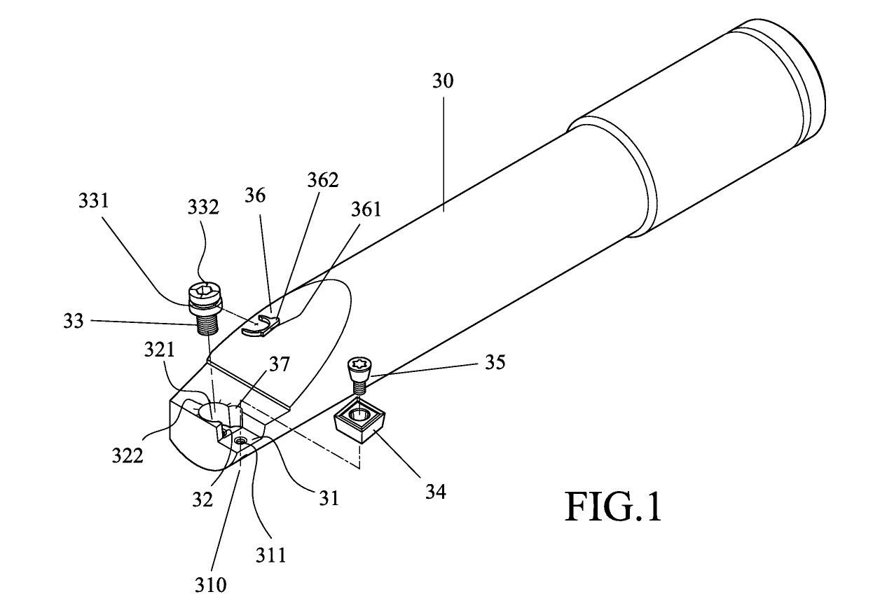

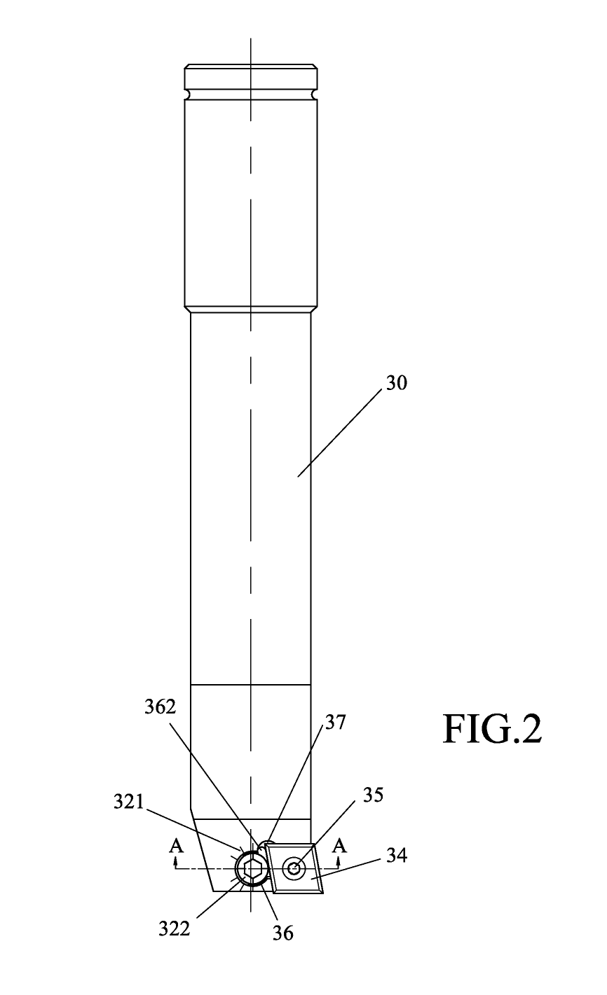

Referring to FIGS. 1, 2, and 3, the present invention is essentially comprised of a bar 30; a blade holder 31 disposed at a terminal of the bar 30 accommodates a disposable blade 34; a blade central axis 310 is defined for the blade holder 31 and a screw hole 311 is disposed along the blade central axis 310; and a fixation screw 35 is provided to lock the disposable blade 34.

A tuning central axis 320 is defined by a side of the blade holder 31; the tuning central axis 320 and the blade central axis 310 define an inclination α, and a countersink hole 321 and a screw hole 32 are disposed along the tuning central axis. The screw hole 32 is installed with a tuning screw 33 and a top of the tuning screw 33 is provided with an indication scale 332 while multiple scales 322 are disposed to the peripheral of the countersink 321. A groove 331 is disposed to a head of the tuning screw 33 to receive insertion of a tuning spacer 36. A slope 361 is provided on one side of the tuning spacer 36 with a retainer 362 extending from one end of the slope 361. The retainer 362 holds against a transfer recess 37 disposed at where between the blade holder 31 and the countersink 321 to prevent the tuning spacer 36 from turning.

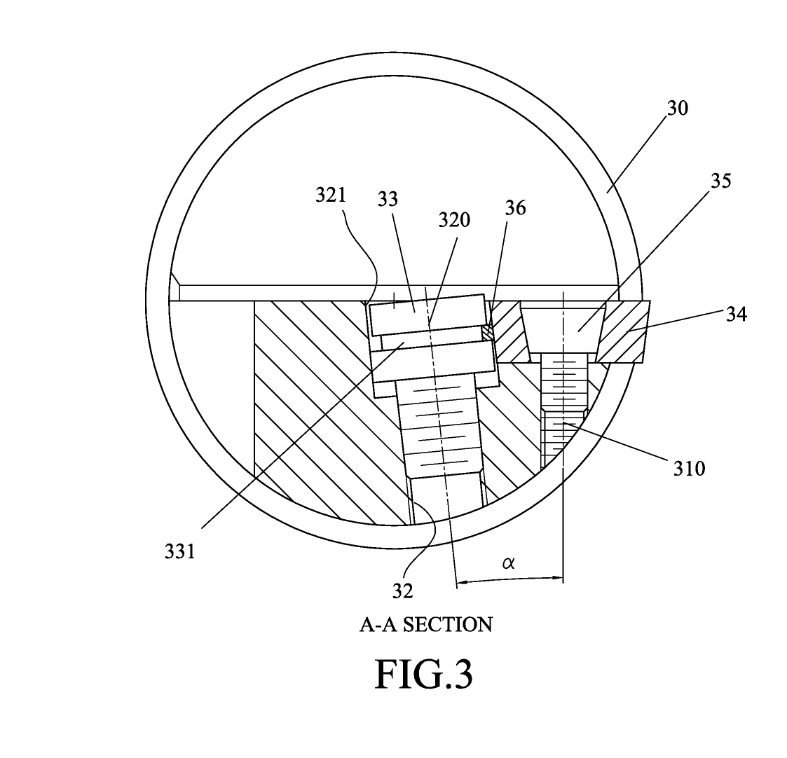

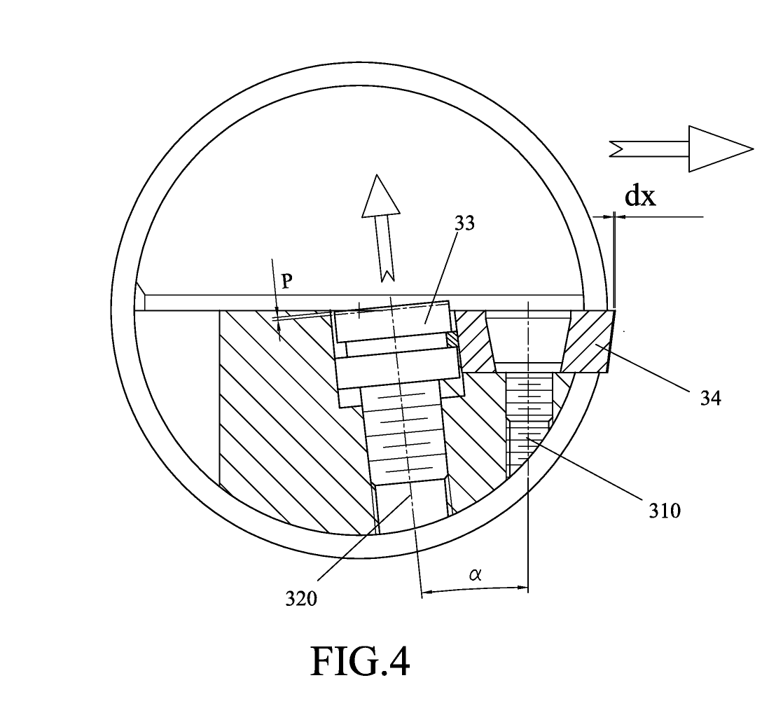

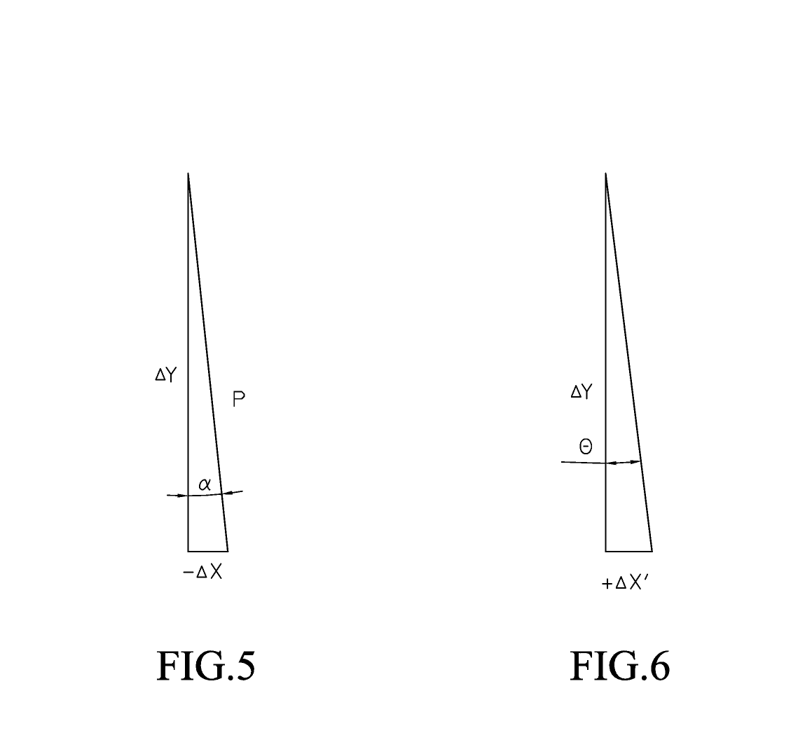

Now referring to FIGS. 3 and 4 for a preferred embodiment of the present invention wherein the tuning central axis deflects counterclockwise, the disposable blade 34 also travels with a smaller amount of displacement when the tuning central axis 320 deflects counterclockwise to achieve more precise tuning amount. The included angle α defined by the tuning central axis 320 deflecting counterclockwise and the blade central axis 310 is equal to 6°. When the turning screw completes one turn to move upward for a pitch, P=0.5 mm, a total displacement amount of the disposable blade 34 is the sum of Δ x (decrement) of the tuning screw 33 in negative X direction and Δ x′ (increment) of the disposable blade 34 in positive X direction, and as illustrated in FIG. 5 related to −ΔX decrement in X direction and ΔY increment in Y direction of the tuning screw 33. Wherein, a hypotenuse represents that the tuning screw 33 moves upper left for a pitch, P=0.5 mm and will travel in negative X direction. The decrement in X direction, −Δx=0.5×Sin 6°→Δx=−0.052264 mm and the increment in Y direction, ΔY=0.5×Cos 6°→ΔY=0.497261 mm; meaning the tuning spacer 36 travels to its left for 0.052264 mm and upward for 0.497261 mm. As illustrated in FIG. 6, a gap angle θ is equal to 7° and when the tuning spacer 36 travels upward for an increment of ΔY=0.497261 mm, the disposable blade 34 will create an increment of Δx′ to its right (in X direction); therefore, Δx′=(0.5×Cos 6°)×tan 7°→Δx′=0.061056 mm; and the total displacement amount of the disposable blade 34 in X direction dx=Δx′−Δx→0.061056 mm−0.052264 mm=0.008792 mm. A boring amount of the tuning screw 33 takes one turn is 0.017584 mm and rounded to the second digital place as 0.018 mm. If the scale 331 of the tuning screw 33 is divided into 18 gradations with each gradation representing a boring amount approximately of 0.001 mm. Accordingly, for adjusting the tuning screw 33 for one gradation, the tuning bar either increases or decreases for 0.001 mm boring amount. When compared to a tuning central axis 320 designed in vertical direction, the tuning amount achieved by the inclination α (6°) is ten-fold minute for the present invention to be applicable for process conditions that demand extremely precise tuning amount.

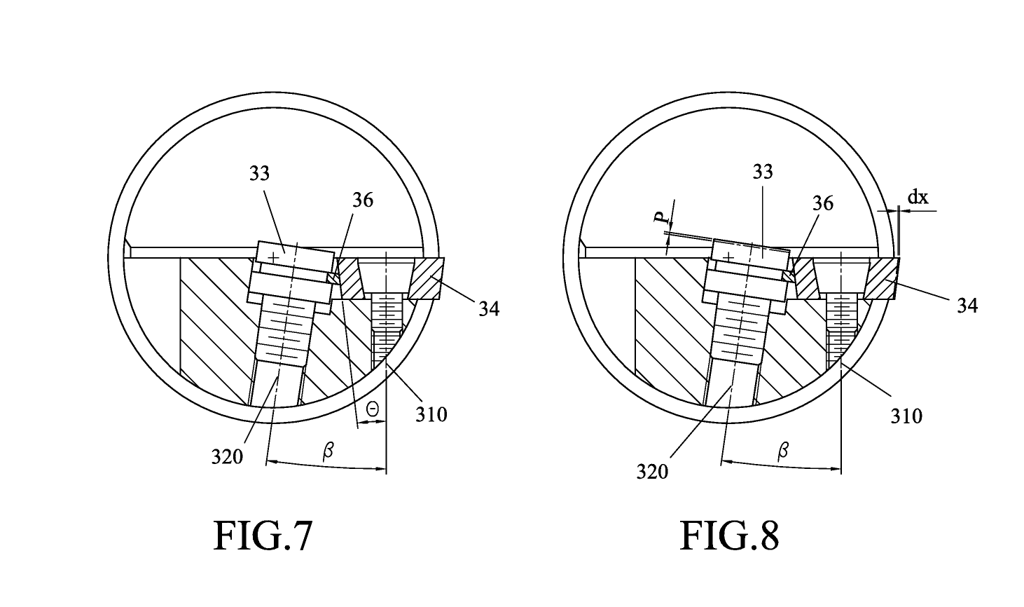

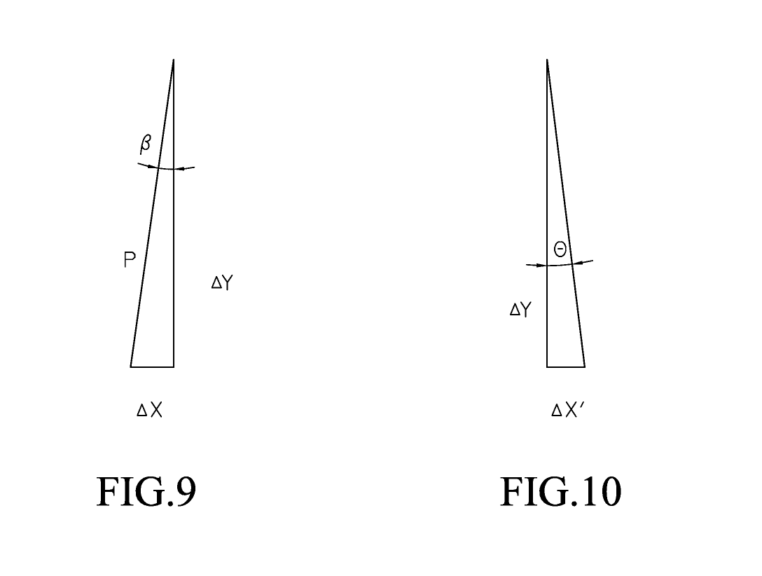

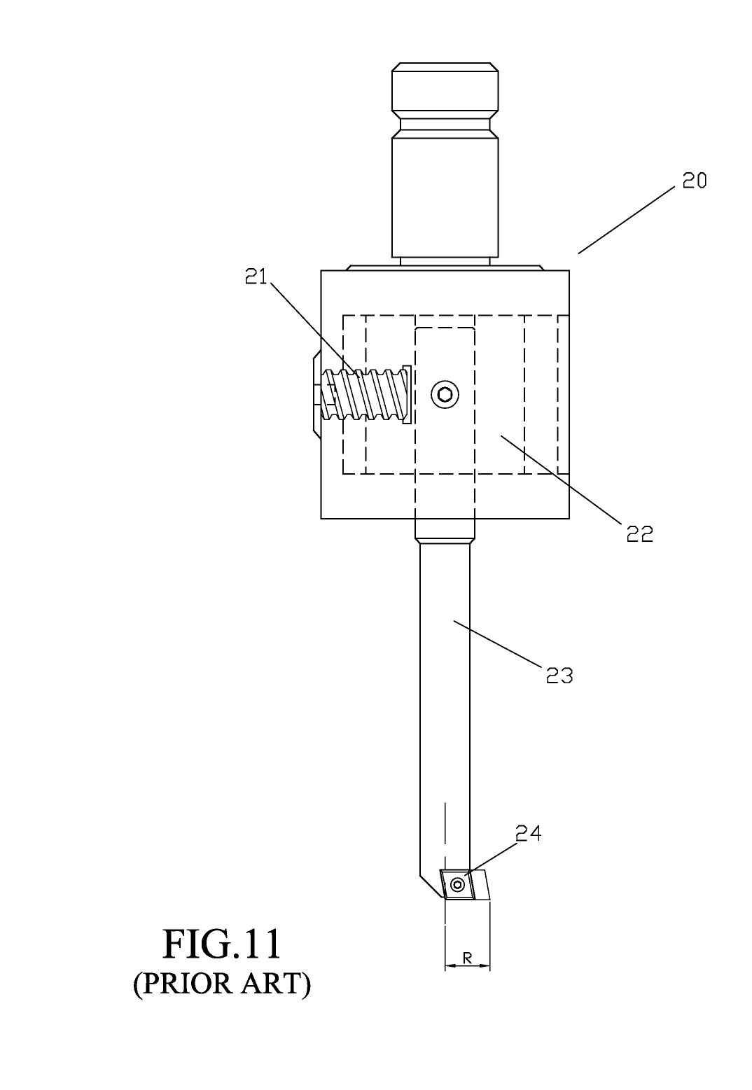

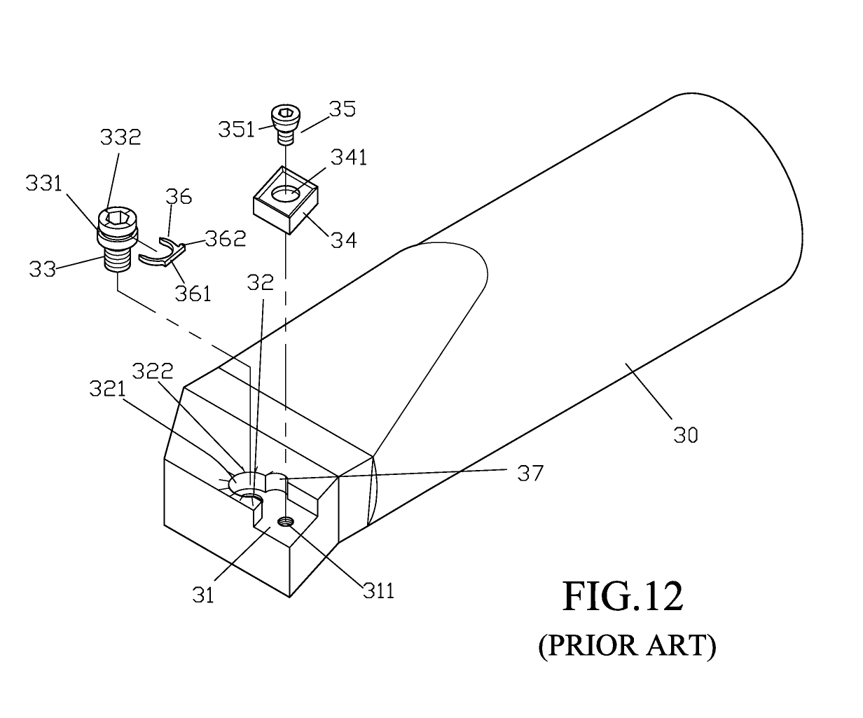

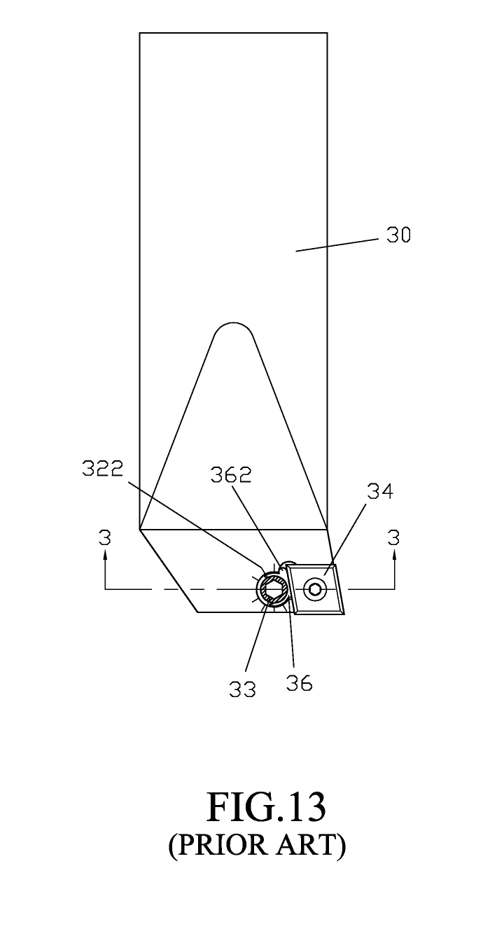

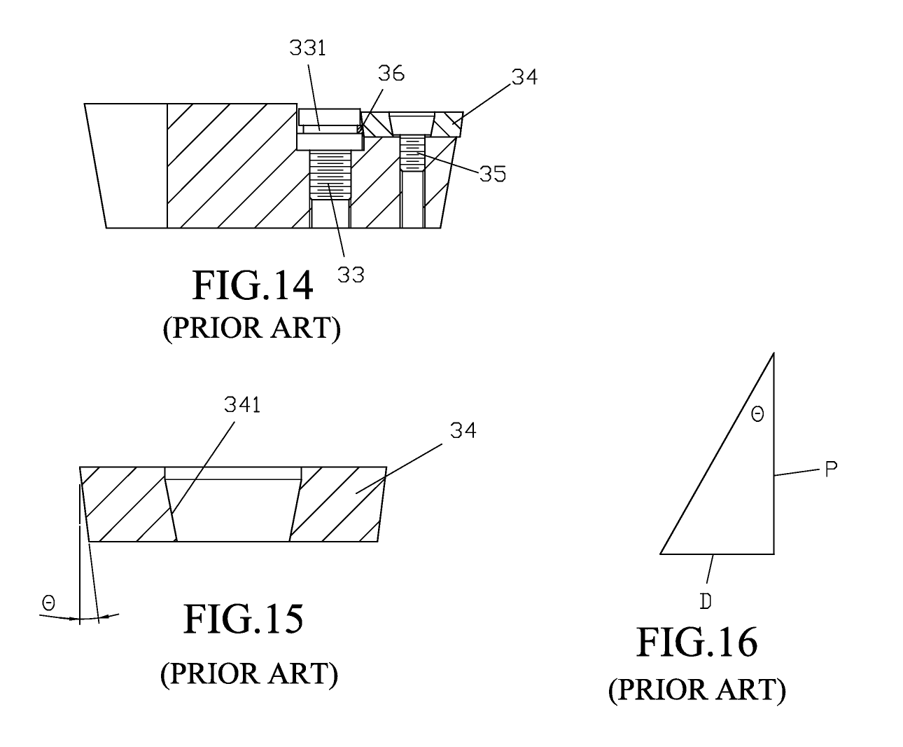

As illustrated in FIGS. 7 and 8 for another preferred embodiment wherein the tuning central axis deflects clockwise and provides greater tuning amount; the disposable blade 34 is given more displacement amount when the tuning central axis 320 deflects clockwise. The tuning central axis 320 rotates clockwise for an angle of β at 8°, indicating an included angle of 8° with the central axis of the blade. When the turning screw 33 rotates for one turn to move upward for a pitch, P=0.5 mm, the total displacement amount of the disposable blade 34 is the sum of an increment Δx of the turning screw 33 in X direction and an increment Δx′ of the disposable blade 34 in X direction and related to Δx and ΔY increments in X and Y directions of the tuning screw 33 as illustrated in FIG. 9, the hypotenuse represents the turning screw 33 travels for one pitch, P=0.5 mm. The increment in X direction, Δx=0.5×Sin 8°→Δx=0.069587 mm and the increment in Y direction, ΔY=0.5×Cos 8°→ΔY=0.495134, representing the tuning spacer 36 moves to its right at the same time for 0.069587 mm and upward for 0.495134 mm. As illustrated in FIG. 10, the increment ΔY for 0.495134 mm of the tuning spacer 36 moving up will drive the disposable blade 34 to move to its right (in X direction) for an increment of Δx′, therefore Δx′=(0.5×Cos 8°)×tan 7°→Δx′=0.60795 mm. Accordingly, the total displacement amount of the disposable blade 34 in X direction=Δx+Δx′→0.069587 mm+0.060795 mm=0.130982 mm. The boring amount is 0.260764 mm for every turn taken by the disposable blade 34. If the scale 331 of the tuning screw 33 is divided into thirteen gradations with each gradation representing a boring amount approximately 0.02 mm, the boring bar either increases or decreases 0.02 mm of boring amount whenever one gradation of the tuning screw 33 is adjusted. When compared to a tuning central axis 320 designed in vertical direction, the tuning amount achieved by the inclination β (8°) is doubled for the present invention to be applicable for process conditions that demand larger tuning amount.

Accordingly, the tuning central axis 320 of the present invention is able to become parallel with the central axis 310 of the blade, execute angular deflection either clockwise or counterclockwise to design an angle of the tuning central axis of the boring bar by changing precision of the tuning amount depending on the required precision of a work piece processed using the boring bar. The present invention provides an innovative structural design of industrial utility by allowing change in great flexibility without the necessity to use other boring bars that prevent easy control of tuning amount or sold at expensive prices, and thus lower the production cost and speed up process speed to upgrade competition strength.

I claim:

1. A boring bar allowing direct tuning comprising a boring bar, having at its terminal disposed with a blade holder to accommodate a blade, the blade holder being defined a blade central axis, a screw hole being disposed along the central axis of the blade, and the blade being locked with a fixation screw; a tuning central axis being defined by a side of the blade holder, the tuning central axis indicating an inclination with the blade central axis, a countersink and a screw hole being disposed along the tuning central axis, the screw hole being engaged by a tuning screw, indication scale being disposed on a top surface of the tuning screw; and multiple scales being disposed in rings to the peripheral of the countersink, a groove being provided on a head of the tuning screw to receive insertion by a tuning spacer, one side of the tuning spacer being related to a slope, a retainer extending from one end of the slope, and the retainer holding against a transfer recess disposed between the blade holder and the countersink to prevent the spacer from turning.

2. The boring bar allowing direct tuning as claimed in claim 1, wherein the tuning central axis deflects clockwise to that of the blade.

3. The boring bar allowing direct tuning as claimed in claim 1, wherein the tuning central axis deflects counterclockwise to that of the blade.
